(19) United States
(12) Patent Application Publication
(10) Pub. No.: US 2025/0182350 A1
(43) Pub. Date: Jun. 5, 2025

(54) Determining Position and Motion of an Object

(71) Applicant: IndieVelo Ltd., Chelmsford (GB)

(72) Inventor: George Gilbert, Chelmsford (GB)

(21) Appl. No.: 18/960,663

(22) Filed: Nov. 26, 2024

(30) Foreign Application Priority Data
Nov. 30, 2023 (GB) 2318336.1

(51) Int. Cl. G06T 11/20; A63B 22/06; A63B 24/00

(52) U.S. Cl. CPC G06T 11/203; A63B 22/06; A63B 24/0021; A63B 2220/16; G06T 2210/21

(57) ABSTRACT

The invention relates to systems, apparatus, and methods for determining position and/or motion of an object, for example, in relation to a pathway and/or another object on the pathway. In one aspect the invention comprises a method (e.g. a computer implemented method) for determining a position and/or motion (e.g. speed and/or acceleration and/or direction of motion etc.) of at least one object (e.g. a person and/or vehicle etc.) moving along a pathway (e.g. in relation to another e.g. a second object, optionally of the same type, (e.g. a person and/or vehicle etc.) moving along a pathway, optionally in a virtual environment), the method comprising: providing, or establishing, at least one pathway (e.g. at least two, preferably a network of pathways); dividing the at least one pathway into a series of (e.g. at least two) pathway elements along the at least one pathway; and, in which at least one (e.g. preferably a plurality of, more preferably most, more preferably all) pathway element(s) comprises a circular arc (e.g. consist(s) of, or comprised only, of a (e.g. only one) circular arc); for at least one object (preferably two or more) moving on (e.g. along) a path on the at least one pathway: associating with the object a pathway identifier for the path the object is moving on (e.g. along); associating with the object a pathway element identifier for the path the object is moving on (e.g. moving along); using the pathway identifier and pathway element identifier as, respectively, first and second co-ordinates of the object moving on the pathway; determining the position and/or motion of the object with respect to the at least one pathway using the first and second coordinates.

### FIELD OF THE INVENTION

The invention relates to systems, apparatus, and methods for determining position and/or motion of an object, for example, in relation to a pathway and/or another object on the pathway.

### BACKGROUND OF THE INVENTION

Exercise machines have been used for many years to facilitate indoor exercise. These can be enhanced by the addition of video screens for entertainment. More recently, these have been used interactively with other players in online virtual games.

US2023211208 WARREN ZWIFT describes an exercise device with control software operating to generate a simulated haptic movement by temporarily altering the resistance applied to the exercise device.

EP3954440 WARREN describes an interchangeable multi-component exercise system.

US2020139194 and US2022062709 MIN ZWIFT describe an interactive network game with game conditions altered based upon physical activity.

The simulation of virtual bicycles on a road network in game play for multiple players is provided by a number of companies, for example:
Peloton (https://www.onepeloton.co.uk/)
Zwift (https://www.zwift.com)
Wahoo RGT (https://uk.wahoofitness.com/wahoo-rgt)
MyWhoosh (https://www.mywhoosh.com/)
Rouvy (https://rouvy.com/)
BKool (https://trial.bkool.com/)

Elite athletes, both in the real world, or when training using exercise machines indoors e.g. alongside simulations, are particularly attuned to deviations from appropriate expected physical feedback from interactions with other athletes and/or the road surface, wind weather etc., e.g. in cycling when drafting, on inclines, in (simulated) wet conditions and so on. Providing realistic real world physical feedback in real time in simulations remains challenging.

Furthermore, existing simulation systems have challenges with performing calculations for multiple objects controlled by multiple users accurately and/or at speed and/or at scale and/or efficiently, e.g. to deliver feedback, to a user such as temporarily altering the resistance applied to an exercise device, in real time

On real-world road networks, advanced driver assistance and autonomous vehicle control remain challenging. There are issues with performing calculations for multiple objects accurately and/or at speed and/or at scale and/or efficiently e.g. to deliver feedback, or predictions, in real time.

WO2016172729 BERKEMEIER describes a drivable path plan system for controlling an autonomous vehicle which uses a clothoid spline between first and second path elements.

EP2172747 DORUM describes the development of a geographic database using Bezier curves for advanced driver assistance systems for motor vehicles.

Neither document address the challenges posed.

The decomposition of an arbitrarily complex curve into arcs is a well-defined mathematical method that has been known and refined for decades. For example, Meek and Walton, Approximating Smooth Planar Curves by Arc Splines, Journal of Computational and Applied Mathematics 59 (1995) 221-231.

This method has been used to improve the smoothness of CNC machines when cutting material and for the rasterization of curved fonts to pixels when displaying text on a computer screen.

U.S. Pat. No. 8,624,899 MICHAIL describes arc spline GPU rasterization for cubic Bezier drawing of 2D shapes.

WO2014025483 GOEL describes GPU accentuated path reading in 2D graphic imaging that uses path segments comprising a line, elliptic arc, quadratic or cubic Bezier curve for drawing 2D shapes.

The present invention seeks to alleviate one or more of the above problems of the prior art described above or elsewhere herein.

The present inventor has identified one or more solutions to improve matters by providing system(s), apparatus, and method(s) of the invention which alleviate or address one or more of the shortcomings mentioned above or elsewhere. In one or more embodiments, the present invention addresses one or more of these challenges, and, for example, facilitates simulations to be calculated more quickly and/or more accurately.

### Problem to be Solved by the Invention

It is an object of the invention to provide improved system(s), apparatus, and method(s) for determining position and/or motion of objects on one or more pathways, and in one or more embodiments, so that potential interactions between objects and/or pathway(s) can be determined and/or predicted more quickly and/or more accurately and/or more efficiently and/or at greater scale.

### SUMMARY OF THE INVENTION

In accordance with a first aspect of the invention, there is provided: a method (e.g. a computer implemented method) for determining a position and/or motion (e.g. speed and/or acceleration and/or direction of motion etc.) of at least one object (e.g. a person and/or vehicle etc.) moving along a pathway (e.g. in relation to another e.g. a second object, optionally of the same type, (e.g. a person and/or vehicle etc.) moving along a pathway, optionally in a virtual environment), the method comprising:
providing, or establishing, at least one pathway (e.g. at least two, preferably a network of pathways);
dividing the at least one pathway into a series of (e.g. at least two) pathway elements along the at least one pathway; and, in which at least one (e.g. preferably a plurality of, more preferably most, more preferably all) pathway element(s) comprises a circular arc (e.g. consist(s) of, or comprised only, of a (e.g. only one) circular arc);
for at least one object (preferably two or more) moving on (e.g. along) a path on the at least one pathway:
associating with the object a pathway identifier for the path the object is moving on (e.g. along);
associating with the object a pathway element identifier (preferably a circular arc pathway element identifier) for the path the object is moving on (e.g. moving along);
using the pathway identifier and pathway element identifier as, respectively, first and second co-ordinates of the object moving on the pathway;
determining the position and/or motion of the object with respect to the at least one pathway using the first and second coordinates (e.g. optionally, at least once, or only once, per a predetermined time period, e.g. 100 μs, or 50 μs, or 20 μs, or 10 μs, or 1 μs, within a preset period of time such as a set number of time units within a simulation, say every 0.01 to 10.0 seconds or more likely 0.01 to 0.5 seconds depending on separation of objects).

In accordance with a second aspect of the invention, there is provided: a system (e.g. an apparatus) for determining a position and/or motion of at least one object (e.g. a person and/or vehicle etc.) moving along a pathway (e.g. in relation to another e.g. a second object, optionally of the same type, moving along a pathway, optionally, on a network of pathways, optionally in a virtual environment), the system comprising:
a machine (e.g. a fitness machine), the machine having a moving user interface operably movable by a user in a manner controllable by a user and by a local controller;
a (e.g. at least one) microprocessor (e.g. a server, such as a centralised server) configured to receive a plurality of input signals representing variables (e.g. position, speed, direction, drafting etc.) associated with position and/or motion of at least one object on at least one pathway (e.g. in a virtual environment), and configured to deliver these to the local controller of the machine;
at least one storage medium associated with the microprocessor (e.g. a server, such as a centralised server) comprising instructions (e.g. executable programmes) for carrying out the method as described herein e.g. as described in any of the claims.

In one or more embodiments, one or more pathway elements comprise (e.g. consist of) straight lines (e.g. the method may determine if a centre of a pathway element is equal to or more than (≥) than a predetermined (e.g. relatively large) amount away, say 1 km or more preferably 10 km or even more preferably 100 km, then that element can be represented as a straight line). In other embodiments, the at least one pathway element comprises only one or more circular arcs. Typically, each pathway element is represented by one circular arc and/or one straight line. More preferably, each pathway element is represented by only one circular arc. Preferably, the circular arc is defined by at least its radius and angle (i.e. angular extent) (r, θ). Preferably, the length of circular arc is defined by its radius and angle (i.e. angular extent) (r, θ).

In one or more embodiments, one or more circular arcs is/are defined by its/their respective radius, angle (i.e. angular extent), and its/their respective centre (e.g. r, θ, C). In one or more embodiments, one or more circular arcs is/are defined by its/their respective radius, angle (i.e. angular extent), optionally its centre, and one or both of its/their respective pitch angle (e.g. an angle α with respect to a horizontal plane) and its their respective roll angle (e.g. an angle β with respect to a horizontal plane) (r, θ, C, α), or (r, θ, C, β), or (r, θ, C, α, β), or (r, θ, α), or (r, θ, β), or (r, θ, α, β). It will be understood that directions of axes of pitch and roll are typically defined as being orthogonal to one another.

In one or more embodiments, the method further comprises using respective first and second co-ordinates of each of a first and a second object to determine the interaction between the first and second objects.

In one or more embodiments, the pathway has a finite (e.g. constant finite or varying finite) width and comprises a reference line (which may be visible or partially visible or not visible) defining the trajectory of the pathway; and, in which
the step of dividing the at least one pathway into a series of pathway elements comprises:
dividing the reference line of the pathway into a series of (e.g. at least two) pathway elements along the reference line of the pathway, in which at least one (e.g. preferably a plurality of) pathway element comprises a circular arc (e.g. optionally, consists of a (e.g. one) circular arc).

In one or more embodiments the method further comprises:
establishing an offset of the at least one object from the reference line;
using the offset of the object from the reference line as a third co-ordinate of the at least one object moving on the pathway;
determining the position and/or motion of the at least one object with respect to the at least one pathway using the first, second, and third coordinates.

In one or more embodiments, the method comprises determining the interaction between the first and second objects at least once, or only once, per preset time period. So at the end of each preset time period, a set of interactions between at least two or more objects has been calculated using at least the first and second coordinates of at least two or more, optionally each or all objects, optionally at least two or more, optionally each or all objects that are determined to be close to each other e.g. on the same pathway and pathway element or on the same pathway and pathway element and within a predetermined lateral offset and so distance from one another.

It will be understood that determining the motion and/or position of the object on the pathway can be carried out using laws of motion for velocity and/or acceleration and the first and second co-ordinates, or first and second and third co-ordinates, where provided.

In one or more embodiments the reference line is a centre line of the pathway.

In one or more embodiments the method further comprises:
determining a lateral offset from the reference line by adding and/or subtracting an offset (e.g. Δr) from a radius of at least one circular arc.

In one or more embodiments, the step of dividing the at least one pathway into a series of pathway elements comprises:
modelling the at least one pathway (e.g. a reference line of the pathway where provided) as one or more (preferably a series of) Bezier curves (preferably cubic Bezier curves);
dividing each Bezier Curve into a series of (e.g. at least two) pathway elements.

Thus in one or more embodiments, the method comprises dividing the one or more Bezier curves into a plurality (e.g. a set or a series) of circular arcs.

Thus in one or more embodiments in which a network of pathways is provided, the method further comprises:
modelling the pathways as one or more Bezier curves; and
dividing the one or more Bezier curves into a plurality (e.g. a set or series) of circular arcs.

In one or more embodiments each Bezier curve is divided into a number of path elements selected from one of: 2 to 12, or 4 to 10, or 6 to 8, or 8.

In one or more embodiments the method two or more objects are provided. For example, the method may comprise for a first object and a second object moving on (e.g. along) a respective path on at least one pathway:
associating with each of the first and second objects, optionally with each of three or more objects, a pathway identifier for the path the respective object is moving on (e.g. along);
associating with each of the first and objects, optionally with each of three or more objects, a pathway element identifier for the path the respective object is moving on (e.g. along);
using the pathway identifier and pathway element identifier of the first and second objects, optionally of each of three or more objects, as, respectively, first and second co-ordinates (optionally, and a third coordinate) of the first and second objects, optionally of each of three or more objects, moving along the pathway;
determining the position and/or motion of the first and second objects, optionally of each of three or more objects, with respect to the at least one pathway using their first and second coordinates (optionally, using their third coordinate);
determining an interaction between the first and second objects, optionally between each of three or more objects, with respect to the at least one pathway using their first and second coordinates (optionally using a third coordinate where provided).

In one or more embodiments the method further comprises:
delivering position and/or motion information derived from the determination (e.g. calculations) in relation to an object and/or the object, to a local controller operatable by a user, the local controller associated with an object (e.g. in a virtual or real environment, to the local controller of a vehicle or other machine, the local controller and/or machine operable by a user e.g. rider or driver or operator).

In one or more embodiments, the or each pathway is divided into a series of pathway elements comprising a series of circular arcs. In one or more embodiments, all the pathway elements each comprise a circular arc. In one or more embodiments, the or each pathway is divided into a series of pathway elements consisting (e.g. consisting only) of a series of circular arcs (e.g. each and every pathway element is a circular arc).

In one or more embodiments, at least one pathway element comprises a straight line.

In one or more embodiments, the pathway element identifier comprises an identifier in a sequence (e.g. a number in a sequence of numbers e.g. 1, 2, 3 or numbered identifier Arc1, Arc2, Arc3 etc.), preferably associated with coordinate parameters e.g. (r, θ) or (r, θ, C), or (r, θ, C, α), or (r, θ, C, β), or (r, θ, C, α, β), or (r, θ, α), or (r, θ, β), or (r, θ, α, β), or (S, C, r, θ, α, β), or (S, r, θ) and so on e.g. in a database. In one or more embodiments, the identifier includes an integral number portion, and a fractional number portion e.g. 4.5, 6.2, 7.257434 etc, the integral number indicating an arc number e.g. in a sequence of arcs numbers, and the fractional portion indicating how far along that arc, e.g. 0.5 of the way along arc number 4 (for a pathway element identifier of 4.5) or 0.257434 of the way along arc number 7 (for a pathway element identifier of 7.257434).

In one or more embodiments, the pathway element identifier comprises a fractional portion (e.g. of pathway element length) identifier.

In one or more embodiments, the method further comprises determining a distance of at least one object along a pathway by adding the lengths of pathway elements together.

In one or more embodiments, the method further comprises determining a distance of at least one object along a pathway by adding the lengths of circular arcs together (where only circular arcs are provided as pathway elements, only lengths of circular arcs may be added).

In one or more embodiments, the method further comprises determining a separation of at least two objects on a pathway by adding and/or subtracting the lengths of circular arcs (where only circular arcs are provided as pathway elements, only lengths of circular arcs may be added and/or subtracted, e.g. arc length=r×θ where r is in length units e.g. metres and θ is in radians).

In one or more embodiments, the method further comprises determining (e.g. calculating) interactions between objects by:
identifying the pathway and if not same, determining no interaction possible (e.g. and/or discontinuing any further calculation);
identifying the distance and/or separation along an identified pathway, and if not within a predetermined limit of separation, determining no interaction possible (e.g. and/or discontinuing any further calculation);
optionally, identifying an offset and/or separation in offset from a reference line of the pathway, and if not within a predetermined limit of separation, determining no interaction (e.g. and/or discontinuing any further calculation);
identifying objects as close enough to interact, and establishing or determining an interaction (e.g. a drafting effect);
delivering control signals reflective of the interaction (e.g. reduction in resistance in a fitness machine for example due to apparently reduced air resistance when drafting, or vice versa).

In one or more embodiments, the method further comprises using the determined interaction to adjust the motion of a or the object.

In one or more embodiments, the method further comprises adjusting the shape and/or size of the circular arc to take account of incline.

In one or more embodiments, the method further comprises delivering control signals to a local controller of a or the object.

In some embodiments, a or the microprocessor is configured to output a predetermined number of intermediate control output signals in a predetermined format to a or the local controller of a machine to control the moving user interface;
at least one of the predetermined number of intermediate control output signals may comprise weighted components of at least two of a plurality of input signals representing variables (e.g. position, speed, direction, drafting etc.) e.g. in a virtual environment (e.g. as described more fully in GB2308317.3)

### BRIEF DESCRIPTION OF THE DRAWINGS

The present invention will now be described, by way of example only, with reference to the following figures in which like reference numerals refer to like features.

FIG. 1 shows a schematic plan view of a pathway, e.g. part of a network of pathways, being described by arcs from three circles according to one embodiment of the invention.

FIG. 2 shows a method of determining position and/or motion of objects on one or more pathways, and in some embodiments, a method of providing a control signal.

### DETAILED DESCRIPTION OF THE INVENTION

The invention has been described with reference to a preferred embodiment. However, it will be appreciated that variations and modifications can be effected by a person of ordinary skill in the art without departing from the scope of the invention.

It will be understood by those skilled in the art that any dimensions and relative orientations such as lower and higher, above and below, inner and outer, and any directions, such as vertical, horizontal, upper, lower, axial, radial, longitudinal, tangential, etc., referred to in this application are within expected structural tolerances and limits for the technical field envisaged and/or the apparatus and/or methods described, and these should be interpreted with this in mind.

Pathway refers to the (e.g. elongate), typically two dimensional (2D), surface over which an object (e.g. person or vehicle) travels, and pathway element means a subsection of the pathway, e.g. along the pathway. Path refers to the actual path trajectory traversed by an object on the pathway and path element means a subsection of the path trajectory traversed by an object.

Reference will be made in the following to training machines, games machines, fitness machines and vehicles such as bikes or cars etc. as objects with which, with commensurate changes, the invention may be used either in simulations and/or real world although the invention is particularly applicable to use in simulated environments.

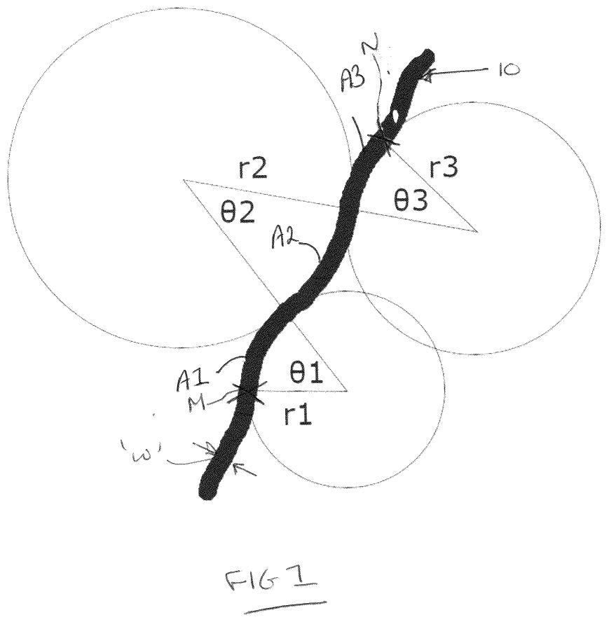

Referring now to FIG. 1, a pathway 10 of finite width w, here constant finite width, is shown. Pathway 10 is typically part of a network of pathways (not shown). Pathway 10 meanders to-and-fro. Pathway 10 can be represented by a series of circular arcs, A1, A2, A3 each of respective length L1=r1.θ1, L2=r2.θ2, and L3=r3.θ3, in radians.

The trajectory followed by pathway 10, and indeed the trajectories of pathways in the network of pathways, may be based on real pathways, such as roads or tracks etc., or may be based on virtual pathways that have been created e.g. for a simulation. In either case, a series of splines, such as Bezier curves, preferably cubic Bezier curves, can be used to represent the pathways. Bezier curves are a type of spline defined by two end points and two control points. This allows complex shapes to be represented mathematically but presents difficulties in calculating positions and interactions of objects on a pathway represented by a Bezier curve in x, y, z coordinates as explained elsewhere. The present invention proposes a simpler approach.

The shape of each pathway can be represented by a series of circular arcs. These circular arcs can be derived by fitting these directly to the shape of the pathway(s), or more preferably, by fitting to Bezier curves which have themselves first been fitted to the pathway. In the following, the method using Bezier curves to derive circular arcs is described as one way of fitting circular arcs to pathways. Other methods can be used as understood by those skilled in the art.

The pathway, or network of pathways, can be based on real pathways, or be created. A 3D drawing program can be used to draw a network of pathways of arbitrary shape in notional 3D space, optionally including inclines and descents etc. In one or more preferred embodiments, the pathways of the network are fitted and/or defined by and/or drawn as one or series of Bezier curves (which may also be referred to by the more general term spline in this document) typically cubic Bezier curves. Typically, the start point of one Bezier curve is the end point of the previous Bezier curve.

Next, these Bezier curves are divided into pathway elements comprising preferably only comprising circular arcs A1, A2, A3 etc. Whilst some pathway elements comprising straight lines may be used this is less preferred although these may be used where the radius is greater than a certain amount, say 1 km or 10 km or 100 km. A subdivision of each Bezier curve is taken, comprising a start point, an end point and a mid-point. This is asserted to be a circle which can be represented by such points, so providing a radius and centre point (r, C).

Next, fitting can be carried out to test the assertion e.g. by any suitable fitting algorithm. One such approach is a trial-and-error algorithm. A circle of given centre C and radius r is fitted to a subsection (also known as a subdivision) of the Bezier curve, and this is iterated (e.g. adjusting the centre and/or the radius) by checking if the fit is improved. In other words, the Bezier curve is subdivided into a plurality of subsections, and each subsection has a circle fitted to it, typically by using a trial-and-error algorithm. These subsections of the Bezier curve are now represented by pathway elements each comprising a circular arc. The start point of one pathway element (e.g. the circular arc) is the end point of the previous pathway element (e.g. the circular arc).

Typically, one or more or each Bezier curve in a pathway or series such as a network of pathways is subdivided into 2 to 12 circular arcs or, more preferably 4 to 10, or even more preferably 6 to 8, or even more preferably 8 circular arcs (A1 to A8). Preferably, these subdivisions of the Bezier curve are of equal angular extent or length, but these may not be.

In some embodiments, the radius and/or centre point of one or more or each circular arc is varied, say by 1 to 2%, to check if this is a better fit to that subdivision of the Bezier curve. A least squares fit or other suitable fit may be used. Typically, the start and end points remain constant and the mid-point is adjusted. Thus, it is preferred if the end of one circular arc forms the start of the next circular arc until the Bezier curve is represented.

Where a virtual pathway represents a real-world pathway, subdivisions of 5 to 15 metres (m), or more preferably 8 to 12 m, or more preferably 5 to 10 m, or even more preferably 10 m, are used to approximate to a single circular arc.

Once the Bezier curves of a pathway have been approximated to a series of circular arcs, the Bezier curves are no longer required.

Referring to FIG. 1, by varying the size, position and number of circles used, the arbitrarily complex shaped road can be accurately described with arbitrarily high precision. The distance from a first position M to second position N is L1+L2+L3 (=r1.θ1+r2.θ2+r3.θ3). Thus, each pathway is divided up into pathway elements of known length, and so known distance from one another along the pathway.

Furthermore, the variation of object position laterally across the width of a pathway can be described by adjusting the radius from a reference line of the pathway (e.g. its centre line). So an object, say a first object, offset by Δr1 inward of a centreline of arc A1, traverses a path around arc A1 of length:

(r1−Δr1).θ1

The positions of objects on the pathway can now be established using a coordinate system based on a pathway identifier (e.g. a pathway number P1, P2, P3 etc.) and a pathway element identifier (e.g. a pathway element number e.g. arc number A1, A2, A3 etc), and optionally also an offset (e.g. lateral offset) identifier Δr1, Δr2, Δr3 etc.

Rather than using x, y, z coordinate system, the positions of each object can now be described by a co-ordinate system based on:
which pathway (e.g. road in a road network) it is on using a pathway identifier;
how far along that pathway (e.g. road) it is (e.g. as measured along the centre line of the road) using a pathway element identifier;
how far away from the centre line of the road it is (perpendicular to the direction of the road) using an offset identifier.

The path of the object on the pathway on the pathway can now be described by coordinates of:
(pathway identifier, pathway element identifier, offset)

This change in coordinate system from classic 3 orthogonal coordinate (x, y, z) uniquely describes the position of an object, but means that the calculations required for determining the position and/or motion of an object e.g. in a simulation (both the interaction with the road, and the interaction between objects) can be:
significantly reduced in number (fewer calculations);
significantly reduced in complexity (faster calculations);
significantly increased in accuracy (better calculations).
   This in turn leads to:
having lower operating costs for running the simulation;
being able to run larger simulations for any given cost;
producing better accuracy simulations.

### EXAMPLE

One example of the specific implementation of the invention is for the computer simulation of virtual bicycles travelling around a virtual road network being operated by a user on a bicycle trainer. This requires extensive physics calculations to be performed to determine how their location in space varies with time due to the constraints of remaining on the road network (e.g. when the road curves around a corner, then the simulated bicycle will follow the road around the corner rather than carrying straight on and off the road, and a user may optionally slow down to allow this to occur), and interactions with other simulated road users (e.g. when they are travelling behind another rider, they experience drafting effects, and/or will steer around each other to avoid collisions between each other).

Where a simulation is intended to reflect real-world experiences by users, the time frame and distances travelled by objects in a simulation, are typically controlled by users who experience time frames and motion in the real world on bicycle trainers (e.g. distance travelled, speed of bike etc) reflective of distances travelled and conditions experienced in the simulation. So 12 km cycled in a simulation whilst on a bicycle training machine, feels like 12 km cycled in the real world, and takes a commensurate amount of time. If this is up a hill it will be harder, or down a hill it will be easier. Control signals reflective of the changing distances and conditions are sent to the machine in the real word e.g. a bicycle trainer, to reflect the actual path e.g. distances travelled and conditions experienced in the simulation.

Traditionally this kind of simulation can be built using a Cartesian (or Geographic) co-ordinate system, with each object to be simulated given an x, y and z coordinate (or latitude, longitude, altitude) in arbitrary three-dimensional space. Calculations could then be made between every pair of objects to determine their relative positions (and therefore what interactions there might be between them) and further calculations made with the position of the road surface to ensure the object stays on the road.

In the general case, the interactions between each of the objects is an N-Squared problem, and therefore very resource intensive/time consuming to calculate, e.g. for simulations with a large number of interacting objects. Furthermore, the calculations involved in determining how to position the objects to make sure that they smoothly go around corners in the road network (an arbitrarily complex curve) are also hard to perform. As a result, significant approximations need to be made to ensure the simulation can run fast enough to be used in real-time, resulting in an inaccurate simulation in such a system.

The decomposition of pathways into a series of arcs, preferably circular arcs, is proposed in various aspects of the present invention. The mathematical principles are known in the art such as in Meek and Walton 1995.

In one or more embodiments, the present invention uses this principle to derive a new coordinate system, and then uses that coordinate system to perform fewer and/or faster and/or more accurate calculations.

### 1) New Coordinate System

The position of an object in three dimensions can be uniquely described by three parameters, for example an x, y and z coordinate in a Cartesian system. Other systems are also available, for example Geographic coordinates might uniquely describe a location by a latitude, longitude and altitude.

Having decomposed an arbitrarily complex road network into a series of arcs, one or more embodiments of the present invention uses this data to create a bespoke coordinate system for the road network, comprising or consisting of
which road it is on (a pathway identifier);
how far along that road it is (in arcs, or fractions of arcs, as measured along a reference line, e.g. a centre line of the road) (a pathway element identifier);
how far away from the reference (e.g. centre) line of the road it is (perpendicular to the direction of the road, in other words perpendicular to a centre line of the road) (an offset identifier).

This bespoke coordinate system may be referred to as an arc spline coordinate system.

In a real-world example, the position of a particular car might be uniquely describable by saying that it is on the M1 motorway, exactly 23 miles along the M1 from the start in London, and in the middle of the fourth lane.

The purpose of doing this is that it greatly simplifies the subsequent calculations about the position and/or movement of objects, as described in the following sections.

### 2) Fewer Calculations

In general, calculating the interactions between arbitrary numbers of objects is an N-Squared problem—the position of every object needs to be compared to the position of every other object to see what level of interaction they have.

By using the above arc-spline coordinate system however, the number of these calculations can be very significantly decreased. For example: It enables the caching of all the objects into ‘buckets’ based on the first coordinate (which road it is on) and only compare objects which are in the same ‘bucket’. Again, to take a real-world analogy, in any given instant, it is never needed to compare whether a car on the M1 motorway is close to or has collided with a car on the M4 motorway because we already know that they are not in the same location by virtue of being on different roads.

These cached ‘buckets’ of objects that are on the same road can also then be used to very quickly reduce the number of complex calculations needed between them. For example, by comparing the distance along each road two objects are (a simple one-dimensional subtraction) it is possible to quickly tell whether an object is close to another object or not, and therefore whether a more complex calculation around the aerodynamic draft one object might provide to another object is needed or not. With a standard coordinate system, this check would need to be performed in three dimensions, and therefore takes more time and computing resources to perform.

Further reductions in the amount of processing needed are also possible. For example, even if two cars are on the same sub-section of the same road, then if they are in different lanes, then they won't need to be checked for colliding against each other, and won't need to be checked to see if they are providing draft for each other. In a bike simulation for example, if two bicycles on the same pathway and same pathway element have greater than a predetermined value of offset between them, these won't need to be checked to see if they are providing draft for each other.

By using an arc spline coordinate system, particularly based on arcs or circular arcs, as proposed in one or more embodiments of the invention, it is therefore possible to dramatically reduce the number of calculations needed to perform a simulation e.g. by multiple orders of magnitude.

### 3) Faster Calculations

Notwithstanding the above reduction in the number of calculations needed in a simulation, the use of the coordinate system of one or more embodiments of the invention also significantly reduces the complexity of the few remaining calculations that are needed.

For example, the path taken by an object as it travels around an arbitrarily complex shaped curve in the road is, by definition, arbitrarily complex.

It requires not only a consideration of what direction the object is moving, but also the curvature of the road, which will continually vary along the length of the section of road the object traverses.

In simulated road networks the calculation may be simplified by considering the road shape to approximate as a Bezier spline (a series of Bezier curves laid end-to-end). Whilst this does change the calculation from being arbitrarily complex to one of just calculating position along a Bezier curve, this is still a relatively computationally difficult calculation.

A coordinate system as proposed in one or more embodiments of the present invention, however, hugely simplifies the calculation of movement around a curve. Because the curve is described as a series of arcs, the simulation only needs to calculate the lengths of arcs, which have mathematically very simple definitions (arc length L=r.θ, where r is the radius and θ is the angular width of the arc) and are extremely computationally quick to calculate.

Other calculations are also greatly simplified by using a coordinate system of the invention e.g. a coordinate system based on circular arcs. For example, when calculating how much aerodynamic draft an object receives from another object ahead of it, it requires detailed consideration of the distances between the two objects and the path the object ahead took when travelling around a curve. If that curve is described by mathematically simple arcs, rather than an arbitrarily complex shape, then these calculations are similarly simplified.

### 4) Better Calculations

As well as being faster, an arc spline coordinate system also allows for simulations to be more accurate.

When calculating the movement of an object along an arbitrary curve, it is not possible to immediately identify what position an object will be in if it moves a given amount. For example, when considering a Geographic coordinate system if an object is in a given starting latitude and longitude and travels 1 kilometre along a wiggly road, it will not finish 1 kilometre away from its starting position. Calculating exactly what latitude and longitude it will be at however is hard and typically involves doing thousands of smaller calculations (where will it be after 1 meter of travel, and then another meter, and then another meter . . . and so on) in a series of small straight lines. This is computationally exceptionally resource intensive, and, even then, will still be inaccurate as the object travels along a curve, not straight lines.

Approximating the road shape to a Bezier spline provides some improvement. However, each constituent Bezier curve is only mathematically described in one dimension (e.g. along the centre line of the road). This means that the calculation of the distance travelled will be inaccurate if applied to an object which is not travelling on the centre line of the road. This kind of implementation is slightly faster than the Geographic coordinate system, but still fundamentally inaccurate.

However, a coordinate system based on arcs, particularly circular arcs, is both fast and accurate. Because the coordinate system has ‘distance along the road’ (e.g. pathway element identifier) as one of its coordinates, then the calculation of where 1 kilometre along the road is, is just adding 1 kilometre to this coordinate. The distance this is in arcs is also well defined and extremely quick and simple to calculate where the arcs are circular arcs—just summing a series of part-circumferences of circles, where the radius of each circle can trivially be adjusted (e.g. increased or decreased) to take into account of the lateral position from the centre line of the object on the road. For example, in FIG. 1 between point M and N, the distance along the road is just (r1.θ1)+(r2.θ2)+(r3.θ3). Once the path and arc number coordinates, and optionally lateral offset coordinate) are known, distance travelled in a time unit, and so speed and acceleration are easy to determine.

This same principle can also be used to simplify many other calculations needed for an accurate simulation. For example, when calculating how far apart two objects are along a road this sum can be quickly and accurately computed in the arc spline coordinate system and gives a more relevant value than calculating how far apart they are ‘as the crow flies’. If one object is at (r1.θ1)+(r2.θ2)+(r3.θ3) and another is at (r1.θ1)+(r2.θ2), then their separation is the difference, namely (r3.θ3).

In one or more embodiments there is provided a novel method of improving efficiency and accuracy when modelling simulated movement along finite width paths in three-dimensional space, for example, a computer simulation of bicycles around a road network, where their positions are limited to being on a road of the network, but could be anywhere on the network.

In one or more embodiments, the invention provides a system, apparatus, and methods for using a coordinate system based on a spline model of pathways, subdivided piece-wise into a series of circular arcs. Use of an arc-spline model of (e.g. finite width) pathways, improves the number of, and speed of, calculations required to simulate the movement of objects along the pathways, and the accuracy of the results of those calculations.

This results in both significantly reduced costs/increased speed, for computing the simulation, and a resulting model that more accurately reflects what would physically happen in the real world.

The realism provided by the fast calculations of embodiments of the present invention provide a significant difference to virtual cycling, particularly to elite cyclists.
A) It is significantly cheaper to run than comparative systems, meaning lower costs for end users.
B) It can run at a significantly larger scale than comparative systems, meaning more users can use it.
C) It is significantly more accurate than comparative systems, meaning a better experience for users.

### Inclines

A circle is a two-dimensional shape. A circular arc is a part of a circle. A pathway, particularly a pathway of finite width, is an inherently 2D structure in 3D space. This is particularly the case for small sections of the pathway (i.e. small sections along the pathway).

In a virtual world, such a pathway, when representing a 3D world, is also inherently a 2D structure, particularly when considered as a series of sections along the pathway, each section being essentially two-dimensional. This is also the case even when taking incline and descent of the pathway, into account.

This means that a series of 2D shapes and in particular one or more circular arcs can be chosen to represent the trajectory of the pathway (e.g. of a reference line such as a centre line of the pathway). Each circular arc, or rather base circle of a circular arc, can be defined as a centre point ‘C’ in x, y, z co-ordinates, a radius ‘r’ in x, y, z co-ordinates, and optionally a pitch angle ‘α’ to a horizontal plane, and a roll angle ‘B’ to the horizontal plane. Each circular arc itself is also defined by an angle θ representing its angular extent.

When the pathway, and so a pathway element e.g. in the form of circular arc (or in some instances a straight line), follows a flat plane, the pitch and roll angles are zero. Where the pathway follows an incline, one or more pathway elements lie in that inclined plane. Thus, the inclined plane, and associated pathway element(s) in it, can be defined as having a pitch angle α in a first direction, and a roll angle β in a second direction perpendicular to the first direction. These two additional parameters pitch angle α, and a roll angle β, can be used as additional coordinates for those pathway element(s). Thus, for example, a circular arc pathway element, and its associated pathway element coordinate, may be defined by a number of parameters which may include one or more of start point (usually the end of the preceding pathway element), centre C, radius, r, angle (of arc) θ, pitch angle α, and roll angle β (e.g. S, C, r, θ, α, β). Thus the first arc may be associated with coordinate Arc 1 which is itself is associated, e.g. in a database, with coordinate parameters e.g. (r, θ) or (r, θ, C), or (r, θ, C, α), or (r, θ, C, β), or (r, θ, C, α, β), or (r, θ, α), or (r, θ, β), or (r, θ, α, β), or (S, C, r, θ, α, β), and so on.

In some embodiments, when gaining height, this height gain can be reflected in positive pitch and/or roll angles for a pathway element. In some embodiments, when losing height, this can be reflected in negative pitch and/or roll angles of the pathway element.

When gaining height, resistance is encountered due to the potential energy gained. This is reflected in the apparent resistance delivered e.g. by control signals to a virtual object in a simulation and/or to a real object, such as a stationary training or game machine, representative of a virtual object in a simulation, and/or to a real object, e.g. a vehicle, in the real world.

For example, for a stationary training machine the control signal(s) is/are used to introduce resistance to a user, so they (and/or an engine) find it harder to propel (e.g. walk along or cycle, or row etc.) the stationary training machine in a simulation.

Similarly, when height is lost, energy is gained and apparent resistance is decreased by control signals to simulate a commensurate increase in speed of (e.g. virtual) objects, and the control signals are delivered to a local controller of an object e.g. a stationary training machine and/or moving vehicle etc.

In one example embodiment, the control signal(s) is/are the control signals are delivered to a local controller of an object and used to reduce resistance to a user so they (and/or an engine) find it easier to propel the object e.g. a stationary training machine and/or moving vehicle etc.

The inclination of a pathway up and/or can be represented by a series of 2D shapes, in particular 2D circular arcs with associated angles of pitch and/or roll to a horizontal plane in x, y, z coordinates. Nevertheless, the length of the pathway and so distance traversed along the pathway is that of the circular arc, not that of the circular arc projected onto a horizontal plane (which is necessarily shorter). Thus, the length of the circular arcs in motion equations for speed, acceleration etc., is a more accurate representation of the actual distance travelled, and can be particularly easy to calculate in embodiments of the invention.

Thus, in one or more embodiments, the present invention uses 2D circles in 3D space to describe a 3D pathway (e.g. a road etc.). The angle of the incline is taken into account by the use of pitch and/or roll angles. The physics of the motion includes the angle of the incline (pitch and/or roll) to take account of this when moving at constant speed and when accelerating or decelerating (e.g. braking).

### Interaction Between Objects

Once the position and/or motion of an object has been established, next, the interaction between objects is assessed. This becomes a much simpler problem when motion of objects is confined to pathways represented by circular arcs, as most and preferably all pathway elements. Further, the interaction of objects with each other is simplified.

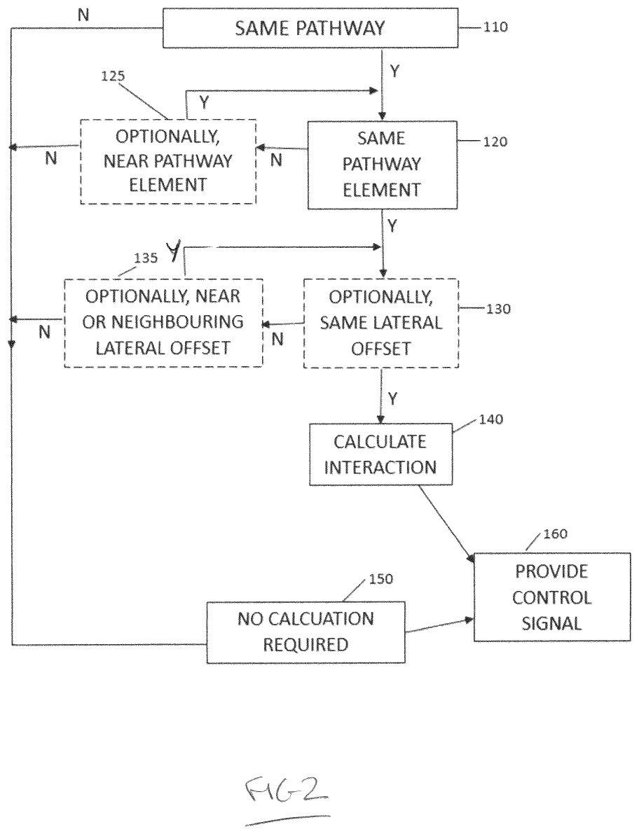

Referring to FIG. 2, first, it is established in step 110 if two objects are on the same pathway (e.g. by comparison of the pathway identifiers of each object) (e.g. the same road or track). Next, in step 120, it is established (e.g. by comparison of the pathway element identifiers of each object) whether the two objects are on the same pathway element (e.g. the same circular arc). If not, optionally in step 125, it is established if the two objects are on near or neighbouring pathway elements. If so, these are optionally returned to the same step of check pathway element in step 120 (e.g. within a preset period of time such as a set number of time units within a simulation, say every 0.01 to 10.0 seconds, depending on separation of the pathway elements).

Optionally, in step 130, a check is performed to establish if the objects are at the same lateral offset from a reference line (e.g. by comparison of the lateral offset identifier). If not, optionally in step 135, a check is performed to establish if these are near or neighbouring. If so, these are optionally returned to the same step of check lateral offset in step 130 (e.g. within a preset period of time such as a set number of time units within a simulation, say every 0.01 to 10.0 seconds or more likely 0.01 to 0.5 seconds, for example depending on separation of lateral offsets).

In step 140, a calculation of the interaction of the objects is performed, e.g. to simulate drafting and/or wind effects. This calculation results in a variation in a control signal directly or indirectly to the object, e.g. to a control system of a fitness machine such as a bike trainer to indicate an increase or decrease in resistance, for example, reflecting the interaction of virtual effects between objects in the simulation.

An example of a bike trainer system suitable for use with the invention is found in co-pending application GB2308317.3.

If, however, the objects are not on the same pathway or not on the same pathway element or, optionally, not on the same lateral offset, no calculation is required. In addition, the calculations become trivial using the co-ordinates system of the invention. The pathway comparison involves a comparative check, e.g. if a number is ascribed to each pathway as a pathway identifier, a simple subtraction can be used. Similarly, for comparison of pathway elements, e.g. if a number is ascribed to each pathway element as a pathway element identifier, a simple subtraction can be used. Similarly, for comparison of lateral offset, e.g. if a number is ascribed to each lateral offset as a lateral offset identifier, a simple subtraction can be used.

In summary, first and second, or first, second and third, coordinates, comprising respectively pathway identifier, pathway element identifier, lateral offset identifier, can be used in one or more embodiments of the present invention. The first co-ordinate, the pathway identifier, is optionally but preferably a sequential integer number. The second co-ordinate, the pathway element identifier (e.g. circular arc pathway element identifier) such as an arc number is optionally a sequential integer number e.g. arc number 4, or more preferably it is a non-integer number, (optionally a non-linear number) such as 4.5, which indicates the object is half way along arc of arc number 4, or 3.75 which indicates it is ¾ of the way along arc number 3. Indeed, even greater accuracy can be provided such as arc number of 7.259865 which for an arc of 10 metre length, represents an accuracy in position of ≤0.01 mm. This may not be necessary although accuracy down to at least ≤10 mm, or ≤1 mm, or ≤0.1 mm is preferred.

A consequence of this part-integer/part-fractional numbering system is that it is non-linear. For example the distance between point 4.5 and point 5.5 is not necessarily the same as the distance between point 5.5 and point 6.5. This is because each arc could be (and usually is) a different length, so for example travelling half way along arc 4 need not be the same distance as travelling half way along arc 6.

Thus, the number has two parts, the part before the decimal point indicating arc number, after the decimal point indicating fractional distance along an arc e.g. of known, e.g. calculable, length. Other numbering regimes associated with the arc number can be used.

The third co-ordinate (e.g. offset), where provided, is optionally but preferably a non-integer number e.g. 4.3 metres, but could be an integer number effectively defining lanes, such as lane 1, 2, 3, 4 etc.

When considering interactions in terms of collisions, a minimum difference in lateral offset can be set, e.g. 1 to 4 m, or 2 to 3 m, or 1 to 2 m. Whilst lanes (as predetermined ranges of lateral offset) within a pathway can be defined, using a continuous range of lateral offset is contemplated in some embodiments. This reflects the fewer calculations already required by excluding non-same pathway interactions and non-same pathway element interactions.

The physics equations of motion (speed, acceleration etc) are applied to each object, optionally once within or at each time segment to determine position on (and/or distance along) a pathway, speed, acceleration and so on, using the first, second and, optionally, the third co-ordinate.

Thus, both fewer and simpler calculations are needed when determining object interactions within a simulation by using the coordinate system provided in one or more embodiments of the invention. Further, by using circular arcs as pathway elements, distance calculations become very simple in radians, as arc length L=r.θ.

In one or more embodiments, in the absence of further input, e.g. the presence of an obstacle, e.g. a stationary obstacle or another moving object, it is assumed that the lateral offset, in other words distance from a reference line, is constant round a corner.

In some embodiments, moving objects may be positioned relative to each other to provide an advantageous position. For example, if the moving objects reflect cyclists or runners, these may be adjusted in relative position (e.g. laterally) to advantage e.g. in a V-shape. For example, depending upon their place, those immediately behind the leader may be placed just to one side to take advantage of draft effects. This involves just one calculation of one parameter, the lateral offset co-ordinate. In some embodiments, such positioning is controllable by a user.

Looking ahead can be very important in simulated environments, e.g. games, as well as in reality to prepare for upcoming road conditions e.g. if a steep hill is approaching and/or in wet conditions a user may choose to slow down. In simulations the view up ahead is prepared by calculations of the pathway and what, if any, other moving objects are present.

In one or more embodiments, the invention provides a control file which comprises control instructions to be used for controlling a machine such as a vehicle or fitness machine. The co-ordinates of one or more or each moving object and the equations of motion are used to determine the effect on the motion of a respective moving object associated with a particular user, e.g. a particular user on a fitness machine, or in a vehicle or vehicle simulation.

By dividing up one or more pathways into pathway elements, optionally having first modelled the pathways as Bezier curves, the pathway elements preferably being represented as circular arcs, the calculations involving position of an object on a network of pathways, and interactions between two or more, typically a multiple of objects, is much simplified.

Thus, the one or more pathways are divided piece-wise, preferably into pathway elements of the same kind, such as arcs, preferably circular arcs. Whilst some straight-line pathway elements may be provided this is less preferred. Dividing a pathway into circular arcs simplifies calculations and enable easy definition of lateral position within a pathway (by lateral offset with reference to a reference line of a pathway) by simply increasing or decreasing the radius r of a circular arc as required.

In practice, when representing motion of objects on a network of pathways as images on a 2D screen, the position and motion information in on or more embodiments of the invention is converted into pixels, in other words rasterised. This, in various embodiments, the invention can be used with rasterisation, in other words converting shapes, e.g. vector-based images, into a raster or a bitmap format, in other words a set of individual pixels which can be displayed on a screen.

In one or more embodiments, the invention relates to systems, apparatus, and methods for determining position and/or motion of an object, for example, in relation to a pathway, and/or in relation to another object on a pathway using arcs, in particular circular arcs to represent splines, particularly splines in the form of Bezier curves. For example the invention may relate to a computer-implemented method which uses a storage media and a microprocessor to carry out instructions as described herein. For example, the instructions may comprise: determining an object (e.g. vehicle) position on a path by: providing a pathway of predetermined width having a reference line; dividing the path into circular arcs; establishing the pathway the object is on; establishing the arc number along the path; establishing a distance of the vehicle from the reference line; using the (path, arc, offset distance) co-ordinates as position co-ordinates for the object.

Variations will be apparent to those skilled in the art from the information herein.

1. A method for determining at least one of a position and/or motion of at least one object moving along a pathway, the method comprising:
providing, or establishing, at least one pathway;
dividing the at least one pathway into a series of pathway elements along the at least one pathway; and, in which at least one pathway element(s) comprises a circular arc;
for at least one object moving on a path on the at least one pathway:
associating with the object a pathway identifier for the path the object is moving on;
associating with the object a pathway element identifier for the path the object is moving on;
using the pathway identifier and pathway element identifier as, respectively, first and second co-ordinates of the object moving on the pathway; and
determining at least one of the position and/or motion of the object with respect to the at least one pathway using the first and second coordinates.

2. A method according to claim 1 in which the pathway has a finite width and comprises a reference line defining the trajectory of the pathway; and, in which
the step of dividing the at least one pathway into a series of pathway elements comprises:
dividing the reference line of the pathway into a series of pathway elements along the reference line of the pathway, in which at least one pathway element comprises a circular arc.

3. A method according to claim 2 comprising:
establishing an offset of the at least one object from the reference line;
using the offset of the object from the reference line as a third co-ordinate of the at least one object moving on the pathway; and
determining the position and/or motion of the at least one object with respect to the at least one pathway using the first, second, and third coordinates.

4. A method according to claim 2 in which the reference line is a centre line of the pathway.

5. A method according to claim 2 comprising:
determining a lateral offset from the reference line by at least one of adding and subtracting an offset from a radius of at least one circular arc.

6. A method according to claim 1 in which the step of dividing the at least one pathway into a series of pathway elements comprises:
modelling the at least one pathway as one or more Bezier curves; and
dividing each Bezier Curve into a series of pathway elements.

7. (canceled)

8. A method according to claim 1 in which two or more objects are provided.

9. A method according to claim 1 comprising:
delivering position and/or motion information derived from the determination in relation to an object and/or the object to a local controller operable by a user, the local controller associated with said object.

10. A method according to claim 1 in which the or each pathway is divided into a series of pathway elements comprising a series of circular arcs.

11-12. (canceled)

13. A method according to claim 1 in which the pathway element identifier comprises an identifier in a sequence.

14. A method according to claim 1 in which the pathway element identifier comprises at least one of: an integral portion identifier) a fractional portion identifier.

15. A method according to claim 1 comprising determining a distance of at least one object along a pathway by at least one of: adding the lengths of pathway elements together, adding the lengths of circular arcs together.

16. (canceled)

17. A method according to claim 1 comprising determining a separation of at least two objects on a pathway by at least one of: adding the lengths of circular arcs, subtracting the lengths of circular arcs.

18. A method according to claim 1 comprising determining interactions between objects by:
identifying the pathway and if not same, determining no interaction possible;
identifying at least one of the distance and separation along an identified pathway, and if not within a predetermined limit of separation, determining no interaction possible;
optionally, identifying at least one of an offset and separation in offset from a reference line of the pathway, and if not within a predetermined limit of separation, determining no interaction;
identifying objects as close enough to interact, and establishing or determining an interaction;
delivering control signals reflective of the interaction.

19. A method according to claim 18 comprising:
using the determined interaction to adjust the motion of a or the object.

20. A method according to claim 1 in which the pathway element identifier is associated with parameters comprising at least one of pitch and roll of at least one circular arc with respect to a horizontal plane, and the method further comprises adjusting at least one of pitch and roll of the circular arc to take account of incline of the pathway.

21. A method according to claim 1 comprising:
delivering control signals to a local controller of a or the object.

22. A system for determining at least one of a position and motion of at least one object moving along a pathway;
the system comprising:
a machine, the machine having a moving user interface operably movable by a user in a manner controllable by a user and by a local controller;
a microprocessor configured to receive a plurality of input signals representing variables associated with at least one of position and motion of at least one object on at least one pathway, and configured to deliver these to the local controller of the machine;
at least one storage medium associated with the microprocessor comprising instructions for carrying out the method of claim 1.

23. A method for determining at least one of a position and motion of at least one object moving along a pathway, the method comprising:
providing, or establishing, at least one pathway;
dividing the at least one pathway into a series of pathway elements along the at least one pathway; and, in which at least one pathway element(s) comprises a circular arc;
for at least one object moving on a path on the at least one pathway:
associating with the object a pathway identifier for the path the object is moving on;
associating with the object a pathway element identifier for the path the object is moving on;
using the pathway identifier and pathway element identifier as, respectively, first and second co-ordinates of the object moving on the pathway;
determining at least one of the position and motion of the object with respect to the at least one pathway using the first and second coordinates;
delivering control signals to a local controller of a or the object.
